(19) United States
(12) Patent Application Publication
(10) Pub. No.: US 2012/0296735 A1
(43) Pub. Date: Nov. 22, 2012

(54) UNIFIED METRIC IN ADVERTISING CAMPAIGN PERFORMANCE EVALUATION

(75) Inventors: Rahul Hari, Bangalore (IN); Balamurugan Subramaniam, Bangalore (IN)

(73) Assignee: Yahoo! Inc., Sunnyvale, CA (US)

(21) Appl. No.: 13/112,301

(22) Filed: May 20, 2011

(51) Int. Cl. G06Q 30/00

(52) U.S. Cl. 705/14.42; 705/14.41

(57) ABSTRACT

The present invention provides techniques that include providing a unified metric for use in advertising campaign performance measurement and evaluation. An advertising campaign may include many aspects, such as portions associated with particular channels and service-providers. Different metrics may be used in measuring performance for particular channels, such as impressions, conversions, etc. Techniques are provided that translate performance of an overall campaign, as well as performance of particular aspects, into terms using a single unified metric measure. Unified metric measures can be used to easily compare campaigns and channels, whether of the same advertiser or against competitors campaigns.

### BACKGROUND

Advertisers, including brand advertisers, typically manage advertising campaigns spanning a variety of media, venues, channels, service providers, etc. However, advertisers have had difficulty in being able to evaluate, such as easily, quickly, and efficiently evaluate, how an advertising campaign is performing, both as a whole across the entire landscape, and with regard to particular forms of media, venues, channels, service providers, etc.

### SUMMARY

Some embodiments of the invention provide methods and systems that include providing a unified metric for use in advertising campaign performance measurement and evaluation. An advertising campaign may include many aspects, such as portions associated with particular channels and service-providers. Different metrics may be used in measuring performance for particular channels, such as impressions, conversions, etc. Techniques are provided that translate performance of an overall campaign, as well as performance of particular aspects, into terms using a single unified metric measure. Unified metric measures can be used to easily compare campaigns and channels, whether of the same advertiser or against competitors campaigns. Additionally, techniques are provided that determine cross-aspects or cross-channel effects within campaigns.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

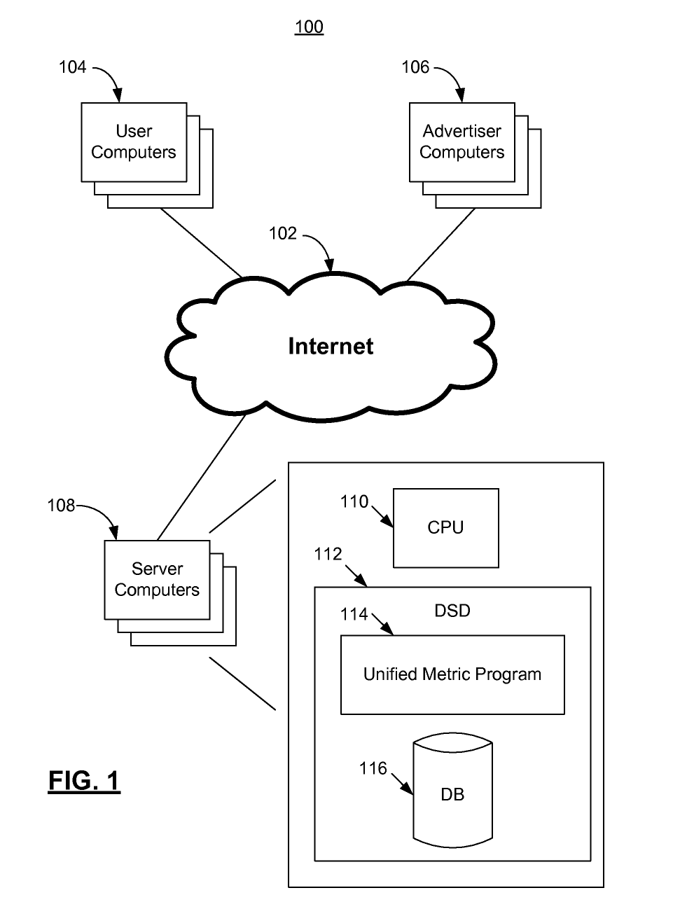

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Unified Metric Program 114.

Herein, the term “advertiser” is intended to broadly include advertisers as well as their agents, representatives, proxies, etc.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

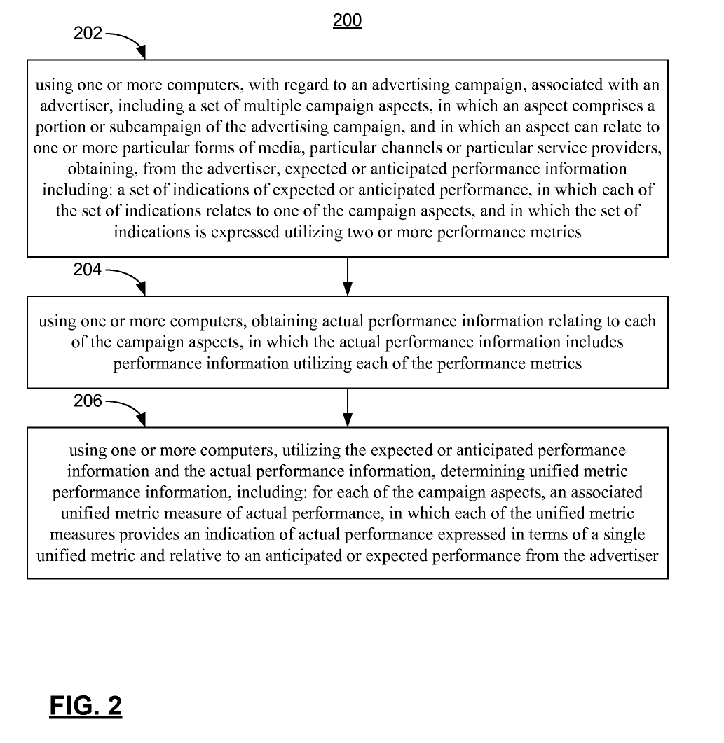

FIG. 2 is a flow diagram illustrating a method 200 according to one embodiment of the invention. Step 202 includes, using one or more computers, with regard to an advertising campaign, associated with an advertiser, including a set of multiple campaign aspects, in which an aspect comprises a portion or subcampaign of the advertising campaign, and in which an aspect can relate to one or more particular forms of media, particular channels or particular service providers, obtaining, from the advertiser, expected or anticipated performance information including: a set of indications of expected or anticipated performance, in which each of the set of indications relates to one of the campaign aspects, and in which the set of indications is expressed utilizing two or more performance metrics.

Step 204 includes, using one or more computers, obtaining actual performance information relating to each of the campaign aspects, in which the actual performance information includes performance information utilizing each of the performance metrics.

Step 206, using one or more computers, utilizing the expected or anticipated performance information and the actual performance information, determining unified metric performance information, including: for each of the campaign aspects, an associated unified metric measure of actual performance, in which each of the unified metric measures provides an indication of actual performance expressed in terms of a single unified metric and relative to an anticipated or expected performance from the advertiser.

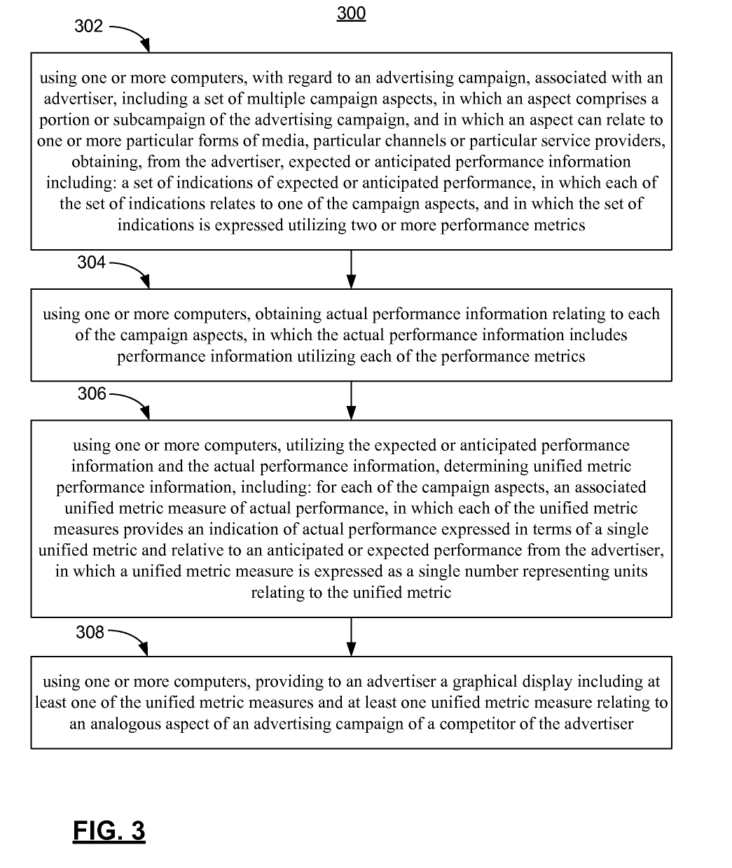

FIG. 3 is a flow diagram illustrating a method 300 according to one embodiment of the invention. Steps 302 and 304 are similar to steps 202 and 204 as depicted in FIG. 2.

Step 306 includes, using one or more computers, utilizing the expected or anticipated performance information and the actual performance information, determining unified metric performance information, including: for each of the campaign aspects, an associated unified metric measure of actual performance, in which each of the unified metric measures provides an indication of actual performance expressed in terms of a single unified metric and relative to an anticipated or expected performance from the advertiser. A unified metric measure is expressed as a single number representing units relating to the unified metric.

Step 308 includes, using one or more computers, providing to an advertiser a graphical display including at least one of the unified metric measures and at least one unified metric measure relating to an analogous aspect of an advertising campaign of a competitor of the advertiser.

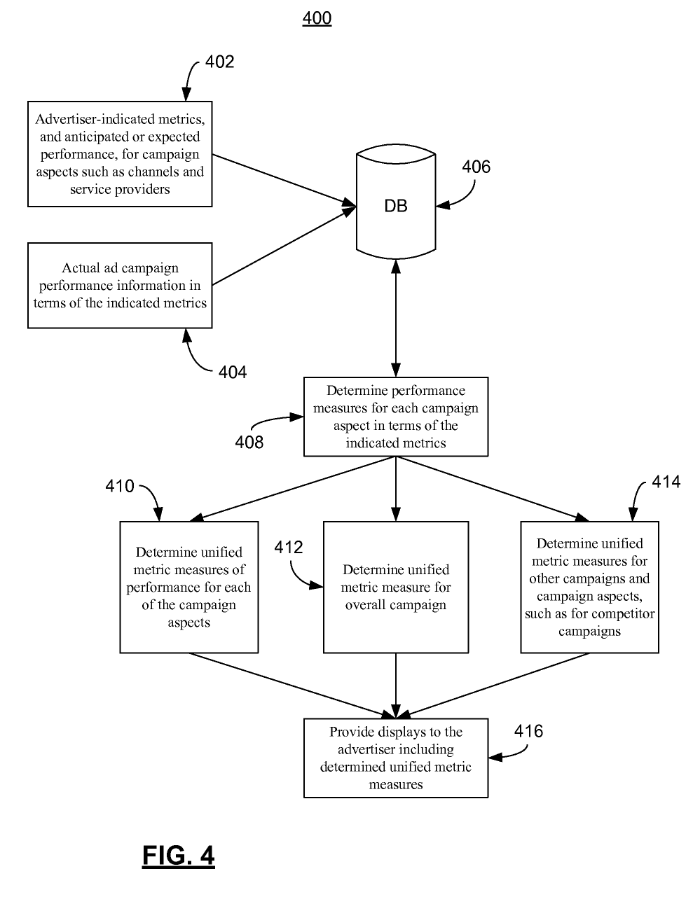

FIG. 4 is a block diagram 400 illustrating one embodiment of the invention. Various information from various blocks may be stored to and obtained from one or more databases, such as database 406.

Block 402 represents advertiser-indicated metrics, and anticipated or expected performance, for campaign aspects such as channels and service providers.

Block 404 represents actual ad campaign performance information in terms of the indicated metrics.

Block 408 represents determination of performance measures for each campaign aspect in terms of the indicated metrics.

Information determined at block 408, among other information, may be used at blocks 410, 412 and 414. In some embodiments, some or any of blocks 410, 412 and 414 may be included, among other things. Specifically, block 410 represents determination of unified metric measures of performance for each of the campaign aspects. Block 412 represents determination of a unified metric measure for the overall campaign. Block 414 represents determination of unified metric measures for other campaigns and campaign aspects, such as for competitor campaigns.

Block 416 represents providing displays to the advertiser including determined unified metric measures, such as those determined at blocks 410, 412 and 414, for instance.

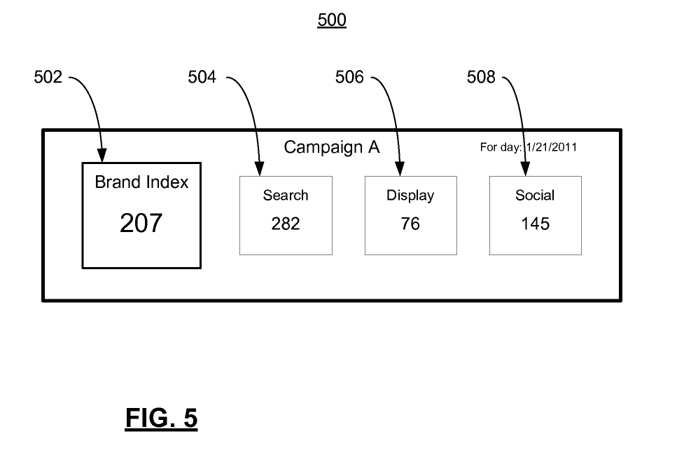

FIG. 5 is a block diagram 500 illustrating one embodiment of the invention, depicted a simplified example graphical display including unified metric measures. As depicted, the display provides performance indications relating to advertising Campaign A on day Jan. 21, 2011. More particularly, the display includes a number of smaller display elements 502-508.

Display element 502 provides an indication of overall campaign performance, in terms of a unified metric, which, in some embodiments, may be called a “brande”. In some embodiments, a unified metric measure may be expressed as a single number, where 100 represents performance as expected or anticipated by the advertiser, and where a score higher or lower than 100 represents better or worse performance than expected or anticipated, respectively.

Display elements 504, 506 and 508 provide unified metric measures of performance of particular aspects of the campaign, such as particular channels. As depicted, elements 504, 506 and 508 relate to performance, in terms of a unified metric measure, of performance of search advertising, non-search display advertising, and social networking-related advertising, respectively. In some embodiments, the overall measure displayed by element 502 may be derived as a weighted combination of performance of multiple campaign aspects, such as those represented by displays 504, 506 and 508. Weighting can be by any of various parameters, such as budget or spend associated with each aspect, for example.

Some embodiments include a recognition that brand marketers have campaigns that may span a variety of aspects, such as media, channels and service providers. But it has been generally difficult to efficiently or optimally know how a campaign is performing across the media landscape, both as a whole and individually on each aspects, such as each channel or service provider.

Some embodiments propose a unified metric called “brande”, which can give a single measure of campaign performance across the whole landscape, or of particular aspects.

Brande may be available at multiple levels, for the whole campaign, which may be a branding campaign, for example, to the level of each service provider within a media channel. This measure can also allow a brand marketer to compare campaign performance against competition. Further, in some embodiments, any cross-aspects, such as cross-channel, influences between the different channels of a campaign can be determined and displayed.

In some embodiments, brande can serve as an intuitive, quick measure of how a brand campaign is performing, now.

Some embodiments include a recognition that, currently, digital media can fragment a brand marketer's audience like never before. In his or her quest to reach out to the target audience, the marketer may employ a variety of different channels (Search, Display, Social Media . . . ) and service providers. This may be in addition to all the existing offline channels (Print, Television, Radio, etc.) and associated service providers. While there may be no way of escaping from this variety of channels and service providers for the foreseeable future, it can be very important that the brand marketer runs his or her campaigns in the most efficient and effective manner. Existing methods have been fragmented and inefficient in this regard. For example, each of the above channels may be measured by its own metrics (for example, clicks for search, impressions for a guaranteed display campaign, etc.).

Additionally, increasingly, activities and performance on one aspects, such as media or channel, may influence another or others. For example, a viral online video campaign could trigger an engaging, positive social media activity very quickly, and that could in turn drive up searches for the brand keywords. As such, some embodiments include measurement of the performance that takes into account these cross-channel effects.

It can be very valuable for a brand marketer to get feedback on performance as the campaign unfolds and convert early trends into big wins.

Another issue for a brand marketer can be the lack of visibility into how the competitors in the same industry are doing with respect to their campaigns. The marketer may ask, how am I as a brand marketer doing vis-à-vis my peers in the industry? Am I doing better or worse?

Additionally, the brand marketer may want to not only measure and know for himself how are things going, but also want something concise that is sharable with management and other stakeholders.

Some embodiments include, given the aspect mix and the inherent advantages of the metrics therein, include choosing a direct metric for a channel, which may be the metric that most directly represents or captures how that channel or service provider is delivering against the expectations from the brand campaign, for example. So, given the brand's marketing objectives, for example, maybe ‘conversions’ makes most sense for the search campaign and ‘impressions’ for the display campaign. In that case, a technique may include picking those two metrics and use those for the brand campaign measurements. It is also permissible to choose some other metric for the same channel some other time. Now these two individual channel metrics (or more if there are additional aspects, such as channels, where the campaign is being run) are translated, for example, into a common, comparable currency or unified metric.

In some embodiments, brande will be a “one-number” that summarizes the campaign performances for all media that the brand is spending marketing dollars on. It could be extended for a campaign that involves both traditional and digital media, paid and earned.

In some embodiments, brande is a measure of how a campaign is performing against the expectations from it, gives visibility at the brand level overall and then individually at each media-channel/service provider level. Brande can be a whole number with a value of 100 denoting that the campaign is performing up to the expectations where as a value above or below 100 denotes that it is performing above or below expectation, respectively.

In some embodiments, brande will also give visibility into how the specific brand's competition is performing with the very same channels/service providers. Points of special interest can be “self-low, vertical high” scenarios where a brand finds that the competition is performing better than the brand in question.

Some embodiments provide a solution that also includes a brand dashboard that may act, for example, as a 10-second accessible window into what is happening with the brand campaign, now.

In some embodiments, brande and the dashboard may provide any of the following: a 24×7, real-time, one-measure of all brand-campaigns' performances; drill-down into each channel/service provider for individual measures; detailed insights visibility into industry's performance for benchmarking self-performance, such as may be called brande^{vert}; visibility into x-channel impacts/influences between media-channels may be given by terms such as brande^{x-chnl-lift} or brande^{x-chnl-dip} as the case may be.

In some embodiments, brande may provide life-time views for cyclical trends and other patterns. Brande may include an ability to plug-in additional business data for a more holistic picture. Such plug-ins could have their own brande-s that exist on their own and contribute to the overall brande (e.g. customer survey data, sales data, CRM data to close the loop, gauge brand campaign impact to top line/bottom line, etc.).

Some embodiments provide mathematical models. For example, a brand's campaign performance may be measured on a daily basis using an index called brande. There may be a brande for the overall brand, which is composed of individual brande-s at the channel and service provider levels.

Some example channels, service providers and metrics are provided in the table below:

TABLE 1

| Channel | Providers | Metrics |
|---|---|---|
| Search | Search providers . . . | Clicks, CPC, CPA, Conversions, |
| | | ROAS . . . |
| Display | Display advertising | Impressions, Clicks, CTR, CPM . . . |
| | providers | |
| Social | Social networking | Reach, Engagement, Sentiment . . . |
| Media | and media | |
| | providers . . . | |

The metrics could be either absolute metrics or normalized ones. Absolute metrics (e.g.: Impressions, Clicks, Conversions, Reach, Engagement, Sentiment) may be those which are pro-rated based on factors like marketing budget, duration etc. whereas the normalized metrics (e.g.: CPC, CPA, ROAS, CTR, CPM) may not be pro-rated.

In various embodiments, a unified metric measure, such as brande, can be calculated in many ways and using various models. In some embodiments, for example, an overall campaign brande can be calculated as a composite of brande over multiple campaign aspects, such as channels. In such a composite calculation, the weights of each channel term can be proportionate, for example, to budget or spend. Individual channel terms can be calculated, for example, by dividing an actual performance measure by an expected or anticipated performance measure. Channel terms can then be weighted and summed, then multiplied by 100, where 100 is performance according to advertiser expectation of anticipation.

Various embodiments of the invention contemplate use of various different models. However, the following is provided as an example of brande calculation according to one embodiment.

The following example includes calculating brande for a campaign (Campaign A) which uses Search channel and with two service providers, say Channel 1 and Channel 2. Assume that the budget allocated for the campaign stays the same for the duration. Use ‘Clicks’ as the metric and the campaign duration is 60 days, starting at Jan. 1, 2012 to Feb. 29, 2012. Total budget for the campaign, USD 150000, is assumed to be allocated between Channel 1 and Channel 2 in the ratio 40:60. Brand marketer expects a total of 1500000 clicks across the whole campaign for the budget allocated.

At the end of day one, suppose that the campaign has delivered 9000 clicks on Channel 1 and 15000 on Channel 2. According to one embodiment, this could translate to overall Campaign A brande of 96 with the individual brande-s for Channel 1 and Channel 2 being 90 and 100 respectively.

According to this example, the overall brand campaign is performing slightly below expectation (96, below 100) and while at the individual service provider levels, Channel 2 seems to be matching expectation (with a score of 100) whereas Channel 1 is below expectation for the day (90 being below 100).

The following is an example of a detailed calculation according to this embodiment, although many models are possible.

### Example Calculation of Daily Budget:

### DayBudget (CampaignA, Search, 1-1-2010)=150000/60=2500

### DayBudget (CampaignA, Search, Channel 1, 1-1-2010)=60000/60=1000

### DayBudget (CampaignA, Search, Channel 2, 1-1-2010)=90000/60=1500

### Expected Clicks:

### Expected(CampaignA, Search, 1-1-2010)=1500000/60=25000

### Expected(CampaignA, Search, Clicks, Channel 1, 1-1-2010)=(1000/2500)*25000=10000

### Expected(CampaignA, Search, Clicks, Channel 2, 1-1-2010)=(1500/2500)*25000=15000

### Example Calculation of Brande:

brande(CampaignA, Search, Clicks, Channel 1, 1-1-2010)=100*9000/10000=90
brande(CampaignA, Search, Clicks, Channel 2, 1-1-2010)=100*15000/15000=100
brande(CampaignA, Search, Clicks, 1-1-2010)=(1000/2500)*90+(1500/2500)*100=36+60=96

It is recognized that the brand marketer is not alone. His or her competitors are also more often than not trying to reach out to the same or similar target audience and many a time through the very same channels and service providers as he or she is. In some embodiments, brande^{vert} will help the marketer see how his campaign stacks against his competitors' campaigns.

In some embodiments, given that each advertiser's campaign has a set of competing campaigns from other advertisers, such groups of competing campaigns are identified and assigned into sets. Each such set may be called Vertical-Campaigns set. Thus each campaign belongs to a unique Vertical-Campaigns set which includes of all competing campaigns including self. Brande^{vert} may then be a measure of how the vertical (a set of competing campaigns) is performing on a whole and on each channel and service provider. This measure can help the advertiser to compare it's brande performance with respect to the vertical.

In some embodiments, such as for data-security reasons, only the aggregate brande^{vert} at campaign level may be made available to an advertiser for the given campaign. Additionally, in some embodiments, to avoid the possibility of making obvious guesses about specific vertical campaign's performance, there may be provision to allow availability of brande^{vert} only if the Vertical-Campaigns set consists of campaigns, the number of which, is greater than some constant c (e.g.: c>=5).

In some embodiments, with the use of the brande^{vert}, now the brand marketer will be proactively alerted of ‘self-low, vertical-high’ scenarios which could be of keen interest to him. ‘Self-low, Vertical-high’ can be instances in the campaign duration period where campaign of the brand marketer in question is performing poor when compared with his competitors/industry. This could even be for a campaign which may otherwise be performing above expectations (with a self-brande of more than 100). This can also work as a self-correcting mechanism and can expose any attempts to achieve a higher brande by setting artificially low expectations. This can be a completely new, powerful capability for a brand marketer.

In campaigns, there can be cross-channel (x-channel) influences between media channels where campaigns are run. The below table, Table 2, captures some of those possible combinations between Search, Display and Social Media. This is a sample illustration only. For example, positive social media activity could trigger interest around a product and drive up search for the brand keywords, or a viral online video could trigger a discussion and sharing of the video in social media circles.

TABLE 2

Effect On

| Effect Of | Search | Display | Social Media |
|---|---|---|---|
| Search | — | No | No |
| Display | Yes | — | Yes |
| Social Media | Yes | Yes | — |

In some embodiments it is recognized that, while the brand marketer may not be directly paying for it, these can all be effects/influences that a brand marketer can consider in determining the effectiveness of the campaign. Some embodiments include a solution that tracks a channel's brande for both (i) x-channel lifts and (ii) x-channel dips, based on whether the impact is positive or negative.

For example, in some embodiments, the solution looks for more than a threshold (configurable and based on history) difference on the brande value of each channel, then determines that as a brande^{delta} to be reported to be brand marketer. The solution can then include looking at other channel performances/brande-s and look for possible triggers or correlations. For example, it can be inquired whether there has been an event in the social media which could have possible been responsible for brande^{delta}. These x-channel effects could also be established with respect to a known trigger like start of the display campaign, setting up a new social media channel etc.

Although many techniques and models are contemplated, in some embodiments, given that some activity/event in one channel can affect the performance of another channel, the former is called the ‘leader’ channel and latter ‘led’ channel. Once a brande^{delta} is established in a channel, all potential leader channels can be scoured for potential triggers/correlations. This is done on the led channel's brande for day+n days. Here, n would be configurable number, for example 3 to 4 days.

In some embodiments, as part of this analysis, if a correlation is established, brandedelta becomes a x-channel lift or dip (brandex-chnl-lift/brandex-chnl-dip) based on the direction of the impact and the same is attributed to that to the appropriate leader channel(s). To get all x-channel effects, the above analysis can be applied to all pair-wise combination of channels.

While the invention is described with reference to the above drawings, the drawings are intended to be illustrative, and the invention contemplates other embodiments within the spirit of the invention.

1. A method comprising:
using one or more computers, with regard to an advertising campaign, associated with an advertiser, comprising a set of multiple campaign aspects, wherein an aspect comprises a portion or subcampaign of the advertising campaign, and wherein an aspect can relate to one or more particular channels or particular service providers, obtaining, from the advertiser, expected or anticipated performance information comprising:
a set of indications of expected or anticipated performance, wherein each of the set of indications relates to one of the campaign aspects, and wherein the set of indications is expressed utilizing two or more performance metrics;
using one or more computers, obtaining actual performance information relating to each of the campaign aspects, wherein the actual performance information comprises performance information utilizing each of the performance metrics; and
using one or more computers, utilizing the expected or anticipated performance information and the actual performance information, determining unified metric performance information, comprising:
for each of the campaign aspects, an associated unified metric measure of actual performance, wherein each of the unified metric measures provides an indication of actual performance expressed in terms of a single unified metric and relative to an anticipated or expected performance from the advertiser.

2. The method of claim 1, comprising determining an overall unified metric measure of actual performance of the advertising campaign overall across all of the campaign aspects.

3. The method of claim 1, wherein a unified metric measure is expressed as a single number representing units relating to the unified metric.

4. The method of claim 1, wherein a unified metric measure is expressed as a single number representing units relating to the unified metric, and wherein a unified metric measure value of 100 indicates performance at a level expected or anticipated by the advertiser.

5. The method of claim 1, comprising providing to an advertiser a graphical display comprising at least two of the unified metric measures, allowing comparison of performance of at least two of the campaign aspects.

6. The method of claim 1, comprising providing to an advertiser a graphical display comprising at least one of the unified metric measures and at least one unified metric measure relating to an analogous aspect of another advertising campaign.

7. The method of claim 1, comprising providing to an advertiser a graphical display comprising at least one of the unified metric measures and at least one unified metric measure relating to an analogous aspect of an advertising campaign of a competitor of the advertiser.

8. The method of claim 1, comprising determining an overall unified metric measure of actual performance of the overall advertising campaign across all of the campaign aspects, and comprising providing to an advertiser a graphical display comprising the overall unified metric measure.

9. The method of claim 1, comprising determining an overall unified metric measure of actual performance of the overall advertising campaign across all of the campaign aspects, and comprising providing to an advertiser a graphical display comprising the overall unified metric measure compared to a unified metric measure of an overall advertising campaign of a competitor of the advertiser.

10. The method of claim 1, wherein the two or more performance metrics comprise an impression-based metric, a click-through based metric, or a conversion-based metric.

11. A system comprising:
one or more server computers coupled to a network; and
one or more databases coupled to the one or more server computers;
wherein the one or more server computers are for:
with regard to an advertising campaign, associated with an advertiser, comprising a set of multiple campaign aspects, wherein an aspect comprises a portion or subcampaign of the advertising campaign, and wherein an aspect can relate to one or more particular channels or particular service providers, obtaining, from the advertiser, expected or anticipated performance information comprising:
a set of indications of expected or anticipated performance, wherein each of the set of indications relates to one of the campaign aspects, and wherein the set of indications is expressed utilizing two or more performance metrics;
obtaining actual performance information relating to each of the campaign aspects, wherein the actual performance information comprises performance information utilizing each of the performance metrics; and
utilizing the expected or anticipated performance information and the actual performance information, determining unified metric performance information, comprising:
for each of the campaign aspects, an associated unified metric measure of actual performance, wherein each of the unified metric measures provides an indication of actual performance expressed in terms of a single unified metric and relative to an anticipated or expected performance from the advertiser.

12. The system of claim 11, wherein at least one of the one or more server computers are coupled to the Internet.

13. The system of claim 11, comprising determining an overall unified metric measure of actual performance of the overall advertising campaign across all of the campaign aspects.

14. The system of claim 11, wherein a unified metric measure is expressed as a single number representing units relating to the unified metric.

15. The system of claim 11, wherein a unified metric measure is expressed as a single number representing units relating to the unified metric, and wherein a unified metric measure value of 100 indicates performance at a level expected or anticipated by the advertiser.

16. The system of claim 11, comprising providing to an advertiser a graphical display comprising at least two of the unified metric measures, allowing comparison of performance of at least two of the campaign aspects.

17. The system of claim 11, comprising providing to an advertiser a graphical display comprising at least one of the unified metric measures and at least one unified metric measure relating to an analogous aspect of another advertising campaign.

18. The system of claim 11, comprising providing to an advertiser a graphical display comprising at least one of the unified metric measures and at least one unified metric measure relating to an analogous aspect of an advertising campaign of a competitor of the advertiser.

19. The system of claim 11, comprising determining an overall unified metric measure of actual performance of the overall advertising campaign across all of the campaign aspects, and comprising providing to an advertiser a graphical display comprising the overall unified metric measure.

20. A computer readable medium or media containing instructions for executing a method comprising:
using one or more computers, with regard to an advertising campaign, associated with an advertiser, comprising a set of multiple campaign aspects, wherein an aspect comprises a portion or subcampaign of the advertising campaign, and wherein an aspect relates to one or more particular forms of media, particular channels or particular service providers, obtaining, from the advertiser, expected or anticipated performance information comprising:
a set of indications of expected or anticipated performance, wherein each of the set of indications relates to one of the campaign aspects, and wherein the set of indications is expressed utilizing two or more performance metrics;
using one or more computers, obtaining actual performance information relating to each of the campaign aspects, wherein the actual performance information comprises performance information utilizing each of the performance metrics; and
using one or more computers, utilizing the expected or anticipated performance information and the actual performance information, determining unified metric performance information, comprising:
for each of the campaign aspects, an associated unified metric measure of actual performance, wherein each of the unified metric measures provides an indication of actual performance expressed in terms of a single unified metric and relative to an anticipated or expected performance from the advertiser;
wherein a unified metric measure is expressed as a single number representing units relating to the unified metric, and
using one or more computers, providing to an advertiser a graphical display comprising at least one of the unified metric measures and at least one unified metric measure relating to an analogous aspect of an advertising campaign of a competitor of the advertiser.
